(19) United States
(12) Patent Application Publication
(10) Pub. No.: US 2006/0147653 A1
(43) Pub. Date: Jul. 6, 2006

(54) Decorative metal wreath

(76) Inventor: Marion Pinkham Karnes, Ashburn, VA (US)

Correspondence Address: Marion Karnes, 21156 Dray Terrace, Ashburn, VA, 20147, US

(21) Appl. No.: 11/029,066

(22) Filed: Jan. 4, 2005

(51) Int. Cl. G09F 19/00; A47G 33/04; B32B 38/14; B32B 37/00

(52) U.S. Cl. 428/10; 156/256; 156/263

(57) ABSTRACT

A decorative wreath comprising a core element with malleable strips of metal woven, tied, or interlaced through the core to create an ornamental design. The metal strips are spray painted in varying patterns, cut with varying widths and lengths, twisted and formed into shapes, and interlaced through the core. Accessories are attached to the wreath depending on the occasion.

### BACKGROUND OF THE INVENTION

This invention relates generally to the field of decorations, particularly to a novel wreath designed for perpetual use.

Wreaths are widely used as decoration during the Christmas holiday season. Although decorative wreaths are available, none of these wreaths are made of malleable metal which provides resistance to harsh weather, durability for continuing use, and attractive reflective characteristics. One example of a prior art wreath may be found in Stolzman U.S. Pat. No. 5,506,009, which teaches wreaths constructed from fabric, ribbon, paper, yarn, tulle, and netting. Another example of a prior art wreath is Scudder U.S. Pat. No. 4,144,365, which teaches use of artificial or natural material, such as natural holly or evergreen materials.

There is a need for a wreath that does not contain expensive greenery requiring annual purchase. There is also a need for a wreath that will allow a plurality of shapes to be easily formed and withstand harsh weather.

### SUMMARY OF THE INVENTION

The invention provides an improved decoration comprising a conventional metal ring core serving as a base for a plurality of malleable metal strips. The malleable metal strips may be cut into varying dimensions and woven, tied, or interlaced through a core to form a decorative wreath. The strips may be twisted into a curled ribbon shape and woven with varying density to provide unique coverage. The strips may also be shaped to fashion decorations including a bow.

The malleable metal strips may be aluminum, brass, copper, tin, lead, gilding metal, silver, gold foil, gold with metalloids, or other malleable metals. In addition the wreath may be constructed of other materials capable of holding their shape such as vinyl or other plastics. These metals may be patina, verdigris, anodized, and spray painted to create an attractive, colored wreath for varying seasons. The metals may also have a different color on either side, creating an attractive design by weaving the strips together. Decorative accessories may be affixed to the wreath using any securing means such as wire. The accessories are chosen based on the occasions, season, or religious holiday. For example, pinecones, bells, ornaments, pumpkins, stars, crosses, and any other appropriate accessories may be attached to the wreath.

The final form of the wreath may be in a conventional circular shape but is not so limited. The shape may be a cross, heart, flag, football, or any other shape as appreciated by those skilled in the art. The final form may be of varying size, including a small circular shape to surround a candle through a large wreath to attach to the side of a department store. If needed a hook, wire, piece of malleable metal, or other affixing means may then be used to attach the wreath to a surface.

### BRIEF DESCRIPTION OF THE DRAWINGS

FIG. 1 is a front elevational view of one preferred embodiment of the invention illustrating a wreath made with malleable metal strips;

FIG. 2 is a front elevational view of a second preferred embodiment of the invention illustrating a wreath made with spiral shaped malleable metal strips; and

FIG. 3 is a flowchart describing a preferred method of making the invention.

### DETAILED DESCRIPTION OF THE PREFERRED EMBODIMENTS

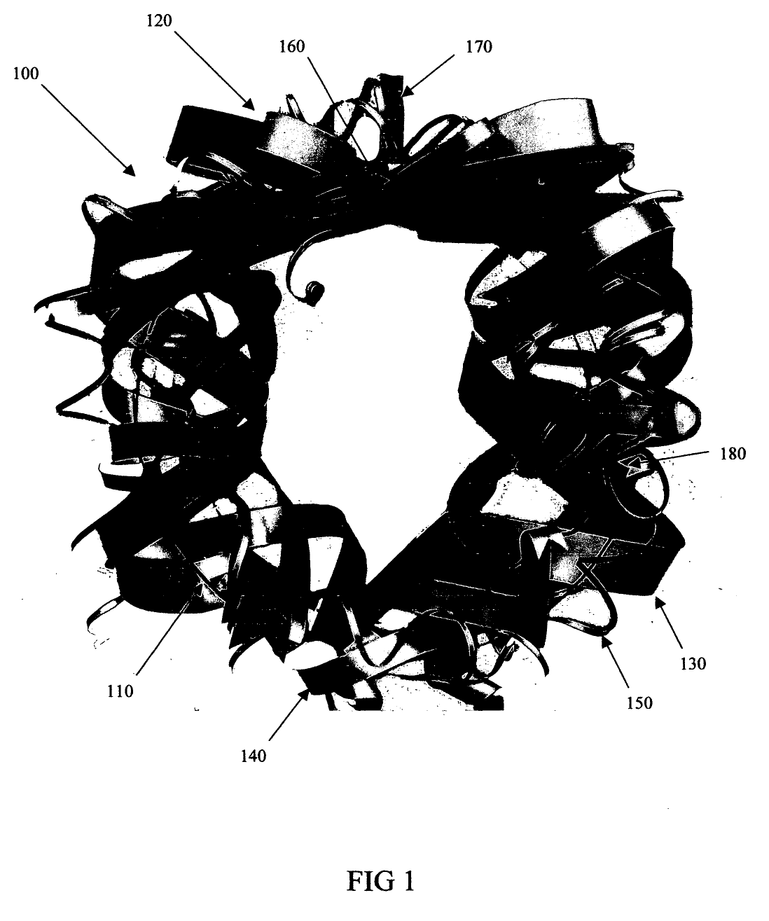

As illustrated in FIG. 1, a wreath 100 comprises a plurality of malleable metal strips 130 having varying thickness. The metal strips 130 may be aluminum, brass, copper, tin, lead, gilding metal, silver, gold foil, gold with metalloids, and other malleable metals. In addition the wreath may be constructed of other materials capable of holding their shape such as vinyl and other plastics.

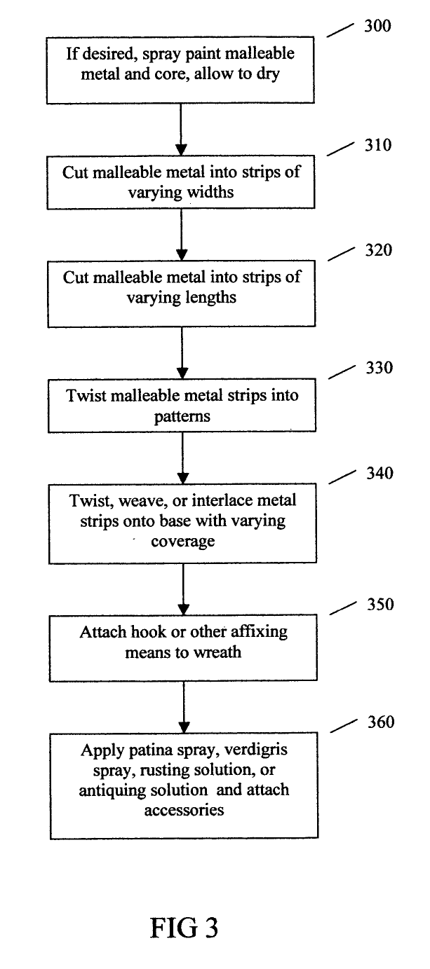

With reference to FIG. 3, a flowchart for making a preferred embodiment is provided. If desired, the sheet of metal is first spray painted and allowed to dry 300. Painters tape may be used to create a striped pattern or a specific pattern may be painted such as an American flag. One or both sides of the metal sheet may be painted in varying color patterns such as red and green for Christmas, orange and black for Halloween, red, white, and blue for July fourth, and other color patterns as desired. Sheet metal may also be purchased anodized, for example with one side silver and the other gold, or one side brown and the other white. Additionally, the core element 110, 210 may be painted with matching color, indoor-outdoor paint, or otherwise treated to match the design of the wreath and withstand adverse weather.

Next the malleable metal strips are cut into any varying widths 310. As seen in FIG. 1, the strips may have a larger width of three-quarters 130, medium width of one half inch 140, and narrow width of one quarter an inch 150. The widths chosen depends on the size and pattern of wreath desired. The strips are cut by hand using tin strips, electric metal shears, or other means of cutting thin metal as appreciated by those skilled in the art.

Next the malleable metal strips are cut into varying lengths 320 depending on the size of wreath desired. In preferred embodiments, for a ten inch diameter wreath four foot long strips may be used, for a fourteen inch diameter wreath six foot long strips may be used, for a twenty-four inch diameter wreath ten foot long strips may be used, and for a thirty inch diameter wreath fifteen foot long strips may be used. However, varying lengths are used to create unique designs for each wreath. The end of the strips may be cut into a V shape 180 or other design pattern.

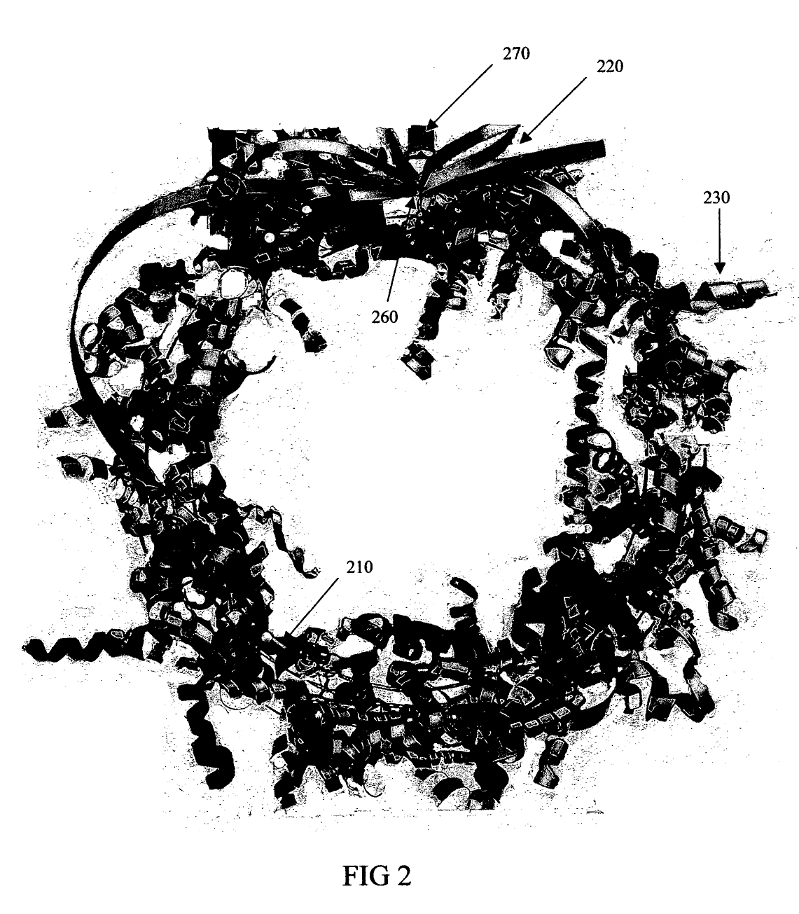

Once the malleable metal is cut into appropriate sized strips, the strips may be bent into patterns 330. The strips may be wrapped around a dowel rod or affixed to a drill to create a spiral design as seen in FIG. 2, item 230. The spiral design may be either cylindrical or angular. Depending on the size of wreath desired, the dowel rod used for cylindrical patterns may have varying thickness, but in a preferred embodiment a dowel with one quarter inch diameter is used. Angular shapes are created by weaving the malleable metal around triangular, rectangular, or other shaped solid.

At item 340 of FIG. 3, the malleable metal strips are then twisted, woven, or interlaced around a core 110, 210. Core 110, 210 may be any shape, design, or pattern as known in the art, but in a preferred embodiment core 110, 210 comprises a ring shape. The malleable metal strips are woven through the core with varying density as desired. The strips may also be shaped into a pattern such as a bow 120, 220. The bow is secured by placing a notch in the metal strips at the center 160, 260 and using a wire or other clamp to hold the bow in place.

Next a hook or other affixing means 170, 270 is secured to the wreath at step 350. The hook may be made of wire, malleable metal, or other means of securing the wreath to a surface such as a door. If the wreath is used as a table centerpiece or to surround a candle, no hook is needed.

Finally, patina spray, verdigris spray, rusting solution, or antiquing spray and accessories may be applied to the wreath at step 360. The accessories include pinecones, bells, ornaments, pumpkins, flowers, stars, seashells, stars, crosses, and other accessories appropriate for the occasion, season, or religious event. The accessories are affixed using a wire, clamp, or other fastening means either to the core 110, 210 or directly to the metal strips.

The decoration may not always be an enclosed wreath but may have the form of a cross, flag, football, or other form depending on the occasion, season, or religious holiday. Additionally, the decorations may have varying size to be used from a table center piece up to a large wreath for the side of a department store.

While there is shown and described specific structure in the shape of a wreath, it is appreciated that many other forms, sizes, and materials may be used without departing from the spirit and scope of the invention. Various modifications to the structure and method of making may be made without departing from the underlying inventive concept.

1. A decorative wreath comprising:
a core element; and
a plurality of malleable metal strips woven through and around the core element in the decorative wreath.

2. The decorative wreath of claim 1, wherein said malleable metal strips comprise at least one of aluminum, brass, copper, lead, tin, gilding metal, silver, or gold foil.

3. The decorative wreath of claim 1, wherein said malleable metal strips comprise varying widths.

4. The decorative wreath of claim 1, wherein said malleable metal strips comprise varying lengths.

5. The decorative wreath of claim 1, wherein said malleable metal strips are painted.

6. The decorative wreath of claim 1, wherein said malleable metal strips are twisted into a spiral pattern.

7. The decorative wreath of claim 1, wherein said malleable metal strips are shaped to form a bow.

8. The decorative wreath of claim 1, wherein said wreath comprises attached accessories.

9. A decorative wreath comprising:
a core element; and
a plurality of malleable plastic strips woven through and around the core element in the decorative wreath.

10. The decorative wreath of claim 1, wherein said malleable metal strips comprise vinyl.

11. The decorative wreath of claim 1, wherein said malleable plastic strips comprise varying widths.

12. The decorative wreath of claim 1, wherein said malleable plastic strips comprise varying lengths.

13. The decorative wreath of claim 1, wherein said malleable plastic strips are painted.

14. The decorative wreath of claim 1, wherein said malleable plastic strips are twisted into a spiral pattern.

15. The decorative wreath of claim 1, wherein said malleable plastic strips are shaped to form a bow.

16. The decorative wreath of claim 1, wherein said wreath comprises attached accessories.

17. A method of making a decorative wreath comprising:
cutting strips of malleable metal or plastic into varying widths and lengths;
interlacing the strips through a core element with varying coverage to form the decorative wreath.

18. The method of claim 17, comprising twisting said strips into a pattern comprising a bow or spiral.

19. The method of claim 17, comprising painting said strips with color spray paint, patina spray, verdigris spray, or rusting solution.

20. The method of claim 17, comprising attaching accessories to said core element or strips.
